(19) United States
(12) Patent Application Publication
(10) Pub. No.: US 2007/0200512 A1
(43) Pub. Date: Aug. 30, 2007

(54) Semiconductor Chip For Driving Light Emitting Element, Light Emitting Device And Lighting Equipment

(75) Inventors: Shusaku Gotou, Kyoto (JP); Tsukasa Kawahara, Kyoto (JP); Tadaaki Ikeda, Kagoshima (JP); Tooru Aoyagi, Kagoshima (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 10/599,998

(22) PCT Filed: Apr. 18, 2005
(86) PCT No.: PCT/JP05/07413

§ 371 Date: Nov. 29, 2006

(30) Foreign Application Priority Data
Apr. 21, 2004 (JP) 2004/125713

(51) Int. Cl. H05B 39/04

(52) U.S. Cl. 315/309

(57) ABSTRACT

A light emitting device is provided to correctly detect a temperature of a light emitting element, and to prevent breakdown or deterioration of the light emitting element. The light emitting device of the invention includes a light emitting element having an electric signal terminal, that is driven by an electric signal given from the outside to the electric signal terminal, and a semiconductor chip for driving the light emitting element, including a light emitting element driving circuit and a temperature detecting element that are made of a semiconductor. The semiconductor chip outputs and applies the electric signal to the electric signal terminal. The temperature detecting element detects an ambient temperature. The light emitting element is mounted on the semiconductor chip for driving the light emitting element, and is driven based on the temperature detected by the temperature detecting element.

### TECHNICAL FIELD

The present invention relates to a semiconductor chip for driving a light emitting element, a light emitting device, and a lighting equipment.

### BACKGROUND ART

Recently, in a mobile telephone, a digital camera, and other electronic appliances, a light emitting device for driving a light emitting element such as a visible light emitting diode (a visible LED) and others, and a lighting equipment having a plurality of the light emitting device are used widely. As the electronic appliances are advanced in the scale of integration, a light emitting device having a smaller mounting area are demanded in a market.

JP-A-2003-8075 (patent document 1) discloses a technology of curtailing a mounting area of a light emitting device by mounting light emitting elements on protective elements to compose one light emitting module. Referring to FIG. 12 and FIG. 13, the light emitting device of prior art disclosed in patent document 1 is described below.

FIG. 12 is a plan view of a structure of the light emitting device in prior art. FIG. 13 is a sectional view along broken line A-A′ in FIG. 12. In FIG. 12 and FIG. 13, same elements are identified with same reference numerals. The conventional light emitting device has substrate wirings 1203 (including a VCC wiring and a GND wiring) on a substrate 1202. A light emitting module 1201, a power supply circuit 104, and a driver IC 1204 are mounted on the substrate wirings 1203. Elements of in the light emitting module 1201, the power supply circuit 104, and the driver IC 1204 are electrically connected by the substrate wirings 1203.

The power supply circuit 104 includes an input capacitor 143 connected between the VCC wiring and the GND wiring, a coil 141 connected to the input capacitor 143 by way of the VCC wiring, a Schottky diode 142 connected to the coil 141 by the substrate wiring 1203, and an output capacitor 144 having one end connected to the Schottky diode 142 and a voltage feedback terminal 125 by way of the substrate wiring 1203, and other end connected to the GND wiring.

In the light emitting module 1201, a lead frame 114 is mounted above the substrate 1202. A Zener diode 1213 is fixed on the lead frame 114. The upside of the Zener diode 1213 is covered with an insulating film 131 except for pad holes 113.

Bumps 115 are put on the pad holes 113 except for the portion near both ends on the Zener diode 1213, and a light emitting element 111 is mounted on the bumps 115. The light emitting element 111 is a visible light emitting diode (LED). The Zener diode 121 protects the light emitting element 111 from electrostatic breakdown or high voltage breakdown.

In FIG. 12 and FIG. 13, two light emitting elements 111 are mounted on two Zener diodes 1213 respectively. In the conventional light emitting device, by mounting light emitting elements 111 on Zener diodes 1213 to form an integrated module, the mounting area becomes smaller than when mounting Zener diodes 1213 and light emitting elements 111 separately.

One end of each one of two bonding wires 116 is connected to the pad hole 113 in the portion near the both ends on Zener diodes 1213. Other end of one bonding wire 116 is connected to an anode side terminal 1253, and other end of another bonding wire 116 is connected to a cathode side terminal 1254.

In the driver IC 1204, the lead frame 114 is mounted above the substrate 1202. A driver IC chip 1212 is fixed on the lead frame 114. The upside of the driver IC chip 1212 is covered with an insulating film 131 except for pad hole 113.

One end of six bonding wires 116 is connected to each one of six pad holes, and other end of each one of bonding wires 116 is connected to each of external connection terminals (including a control terminal 123, a voltage feedback terminal 125, a switching terminal 124, a current feedback terminal 126, a VCC terminal 121 ,and a GND terminal 122). Thus, through plural bonding wires 116, the driver IC chip 1212 is electrically connected to the external connection terminals.

The VCC 121 terminal is connected to the VCC wiring. The GND terminal 122 is connected to the GND wiring. The control terminal 123 is a terminal for receiving a signal for switching on/off the driver IC 1204.

The switching terminal 124 is connected to the anode terminal of the Schottky diode 142 and the coil 141 by means of the substrate wiring 1203. The voltage feedback terminal 125 is connected to the cathode terminal of the Schottky diode 142, the anode side terminal 1253 of the light emitting module 1201, and the output capacitor 144 by means of the substrate wiring 1203. The current feedback terminal 126 is connected to the cathode side terminal 1254 of the light emitting module 1201 by means of the substrate wiring 1203.

Patent document 1: JP-A-2003-8075

### DISCLOSURE OF THE INVENTION

Problems to be Solved by the Invention

The light emitting element is desired to have higher luminance, and the power consumption of the light emitting element tends to increase year after year. Since the photoelectric conversion efficiency of the light emitting element is about 30%, 70% or more of the power consumption of the light emitting element is spent as heat, and the temperature of the light emitting element is raised. In particular, when the light emitting element is used continuously in the condition of high temperature over a operation guarantee temperature range, the element may be broken or deteriorate. To use the light emitting element within the operation guarantee temperature range of light emitting element, it is required to control the operation of the light emitting element by using a temperature detecting element for detecting the temperature of the light emitting element.

In the conventional light emitting device, however, since the temperature detecting element cannot be installed in the light emitting module 1201, in most cases, temperature detecting element is not installed (hence, the temperature detecting element is omitted in FIG. 12 and FIG. 13). When the temperature detecting element is installed in the conventional light emitting device, the temperature detecting element is mounted on the driver IC 1204. That is, since the temperature detecting element is installed outside of the conventional light emitting module 1201, the temperature of the light emitting element 111 cannot be detected accurately. In the conventional light emitting device, therefore, it was difficult to control operation of the light emitting element based on its temperature. The conventional light emitting device had possibility of deterioration or breakdown of the light emitting element due to temperature rise by heat generation of the light emitting element.

The invention is intended to solve these problems, and it is hence an object thereof to present a semiconductor chip for driving a light emitting element that accurately detects a temperature of the light emitting element by installing a temperature detecting element at a position closer to the light emitting element than in the prior art, and a light emitting device and a lighting equipment using the same.

The invention is also intended to present a semiconductor chip for driving a light emitting element capable of stopping heat generation of the light emitting element by stopping operation of a driver IC when temperature of the light emitting element exceeds an upper limit, thereby preventing breakdown or deterioration of the light emitting element, and a light emitting device and a lighting equipment using the same.

It is a further object of the invention to present a semiconductor chip for driving a light emitting element for adjusting the white balance of three primaries of red, green and blue colors depending on temperature by accurately detecting temperature of the light emitting element, and a light emitting device and a lighting equipment using the same.

Moreover, it is an object of the invention to present a semiconductor chip for driving a light emitting element having a small mounting area, and a light emitting device and a lighting equipment using the same.

Means for Solving the Problems

To solve these problems, the invention has the following structures.

A light emitting device according to one aspect of the invention has a light emitting element having an electric signal terminal, that is driven to emit light by an electric signal given from outside to the electric signal terminal; and a semiconductor chip for driving the light emitting element, including a light emitting element driving circuit and a temperature detecting element that are made of a semiconductor. The light emitting element driving circuit outputs and applies the electric signal so the electric signal terminal. The temperature detecting element detects an ambient temperature. The light emitting element is mounted on the semiconductor chip for driving the light emitting element, and is driven based on the temperature detected by the temperature detecting element.

According to the invention, by mounting the light emitting element on the semiconductor chip for driving the light emitting element (driver IC chip), and incorporating the temperature detecting element in the driver IC chip, the temperature of the light emitting element can be detected accurately at a very close distance, and the light emitting device of small mounting area is realized. Also in the invention, for example, by stopping the operation of the driver IC when the temperature is high, heat generation of light emitting element is stopped, and the light emitting device capable of preventing breakdown or deterioration of light emitting element is realized.

In the light emitting device according to another aspect of the invention, at least part of the temperature detecting element is disposed in a light emitting element disposed region that is a minimum region including the light emitting element projected on the semiconductor chip for driving the light emitting element.

According to the invention, the light emitting device capable of detecting the temperature of the light emitting element accurately is realized.

In the light emitting device according to other aspect of the invention, the light emitting element driving circuit is formed in the semiconductor chip for driving the light emitting element excluding the light emitting element disposed region.

If the light emitting element driving circuit (driver circuit unit) is disposed in the light emitting element disposed region, heat generation of light emitting element and heat generation of driver circuit unit are concentrated locally, and the temperature may be raised. Accordingly, the driver circuit unit is formed in the region of the driver IC chip excluding the light emitting element disposed region, and the generated heat is dispersed on the driver IC chip, so that local temperature peak can be suppressed. According to the invention, the light emitting device capable of preventing deterioration or malfunction of light emitting element or driver circuit unit due to temperature rise is realized.

In the light emitting device according to other aspect of the invention, the light emitting element is a plurality of visible light emitting elements that emit light at different wavelengths, and the semiconductor chip for driving the light emitting element drives the light emitting elements individually to maintain white balance of the plurality of light emitting elements based on the temperature detected by the temperature detecting element.

The light emitting elements have own temperature characteristics depending on the types. For example, a red light emitting diode is larger in drop of luminance when the temperature is raised, as compared with a blue light emitting diode or a green light emitting diode. In a light emitting device for color display having a plurality of visible light emitting elements emitting in red, green and blue colors, it is important to maintain the white balance on whole region of operating temperature range.

Conventionally, it was difficult to detect the temperature of light emitting element accurately, and hence it was difficult to adjust the luminance of plurality of visible light emitting elements emitting in red, green and blue colors depending on temperature. If the plurality of visible light emitting elements emitting in red, green and blue colors were disposed separately, it was necessary to provide each light emitting element with temperature detecting element, which was very costly.

According to the invention, since the temperature of light emitting element can be detected accurately, an inexpensive light emitting device capable of adjusting the white balance of RGB depending on temperature is realized.

A lighting equipment according to one aspect of the invention includes a plurality of the above-mentioned light emitting devices.

The invention realizes the lighting equipment having the above effects.

A semiconductor chip for driving a light emitting element according to one aspect of the invention is capable of mounting the light emitting element. The light emitting element has an electric signal terminal and is driven to emit light by an electric signal given to the electric signal terminal from outside. The semiconductor chip has: a light emitting element driving circuit that outputs and applies the electric signal to the electric signal terminal; and a temperature detecting element that detects an ambient temperature. The semiconductor chip drives the light emitting element based on the temperature detected by the temperature detecting element.

According to the invention, by mounting the light emitting element on the semiconductor chip for driving the light emitting element (driver IC chip), and incorporating the temperature detecting element in the driver IC chip, the semiconductor chip for driving the light emitting element that accurately detects the temperature of the light emitting element at a very close distance and have a small mounting area can be realized. Also in the invention, for example, by stopping the operation of the driver IC when the temperature is high, heat generation of the light emitting element is stopped, and the semiconductor chip for driving the light emitting element can prevent breakdown or deterioration of the light emitting element.

In the semiconductor chip for driving the light emitting element according to another aspect of the invention, at least part of the temperature detecting element is disposed in a light emitting element disposed region which is a minimum region including the light emitting element projected on the semiconductor chip for driving the light emitting element.

According to the invention, the semiconductor chip for driving the light emitting element capable of detecting the temperature of the light emitting element accurately is realized.

In the semiconductor chip for driving the light emitting element according to other aspect of the invention, the light emitting element driving circuit is formed in the semiconductor chip for driving the light emitting element excluding the light emitting element disposed region.

If the light emitting element driving circuit (driver circuit unit) is disposed in the light emitting element disposed region, heat generation of light emitting element and heat generation of driver circuit unit are concentrated locally, and the temperature may be raised. Accordingly, the driver circuit unit is formed in the region of the driver IC chip excluding the light emitting element disposed region, and the generated heat is dispersed on the driver IC chip, so that local temperature peak can be suppressed. According to the invention, the semiconductor chip for driving the light emitting element capable of preventing deterioration or malfunction of light emitting element or driver circuit unit due to temperature rise is realized.

In the semiconductor chip for driving the light emitting element according to other aspect of the invention, the light emitting element is a plurality of visible light emitting elements that emit light at different wavelengths, and the semiconductor chip for driving the light emitting elements drives the light emitting elements individually to maintain white balance of the plurality of light emitting elements based on the temperature detected by the temperature detecting element.

According to the invention, since the temperature of light emitting element can be detected accurately, an inexpensive semiconductor chip for driving the light emitting element capable of adjusting the white balance of RGB depending on temperature is realized.

While the novel features of the invention are set forth particularly in the appended claims, the invention, both as to organization and content, will be better understood and appreciated, along with other objects and features thereof, from the following detailed description taken in conjunction with the drawings.

It will be recognized that some or all of the drawings are schematic representations for purposes of illustration and do not necessarily depict the actual relative sizes or locations of the elements shown.

### EFFECTS OF THE INVENTION

The invention provides a semiconductor chip for driving a light emitting element that accurately detects the temperature of the light emitting element, a light emitting device, and a lighting equipment using the same.

According to the invention, by stopping the operation of the driver IC when the temperature of the light emitting element exceeds the upper limit, a semiconductor chip for driving a light emitting element that stops heats generation of the light emitting element and prevents breakdown or deterioration of the light emitting element, a light emitting device, and a lighting equipment using the same can be realized.

According to the invention, a semiconductor chip for driving a light emitting element capable of preventing deterioration or malfunction of the driver circuit unit due to temperature rise, a light emitting device, and a lighting equipment using the same are realized.

According to the invention, a semiconductor chip for driving a light emitting element capable of adjusting the white balance of red (R), green (G), and blue (B) colors according to temperature, a light emitting device, and a lighting equipment using the same area realized.

According to the invention, a semiconductor chip for driving a light emitting element having a small mounting area, a light emitting device, and a lighting equipment using the same can be realized.

### BRIEF DESCRIPTION OF THE DRAWINGS

FIG. 1 is a plan view of a light emitting device in an embodiment 1 of the invention.

FIG. 2 is a sectional view cut along broken line A-A′ in FIG. 1.

FIG. 3 is a magnified front sectional view showing a position of a temperature detecting element in the embodiment 1 of the invention.

FIG. 4 is a plan view showing the position of temperature detecting element in the embodiment 1 of the invention.

FIG. 5 is a circuit diagram of the light emitting device in the embodiment 1 of the invention.

FIG. 6 is a front view showing a position of a driver circuit unit in the embodiment 1 of the invention.

FIG. 7 is a plan view showing the position of the driver circuit unit in the embodiment 1 of the invention.

FIG. 8 is a plan view of a light emitting device in an embodiment 2 of the invention.

FIG. 9 is a circuit diagram of the light emitting device in the embodiment 2 of the invention.

FIG. 10 are circuit diagrams of a temperature detecting element in an embodiment 3 of the invention.

FIG. 11 are diagrams showing a position of a temperature detecting element in an embodiment 4 of the invention.

FIG. 12 is a plan view of a light emitting device in prior art.

FIG. 13 is a sectional view cut along broken line A-A′ in FIG. 12.

### BEST MODE FOR CARRYING OUT THE INVENTION

Embodiments of the best mode for carrying out the present invention will be described with reference to the drawings hereinafter.

### Embodiment 1

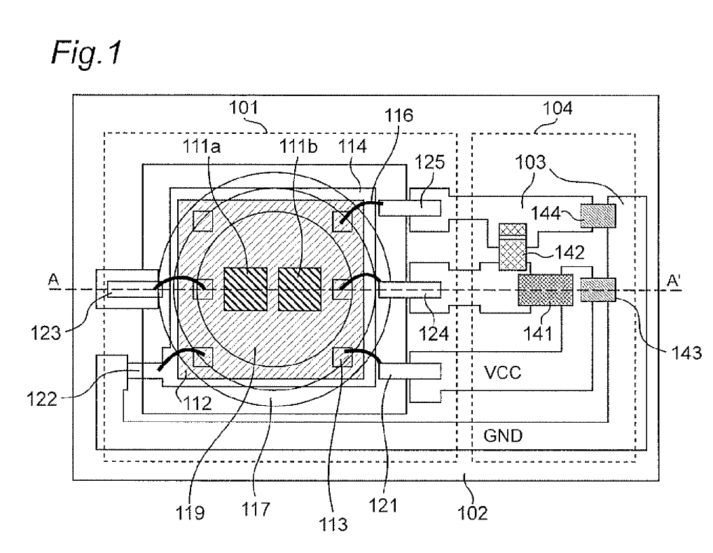

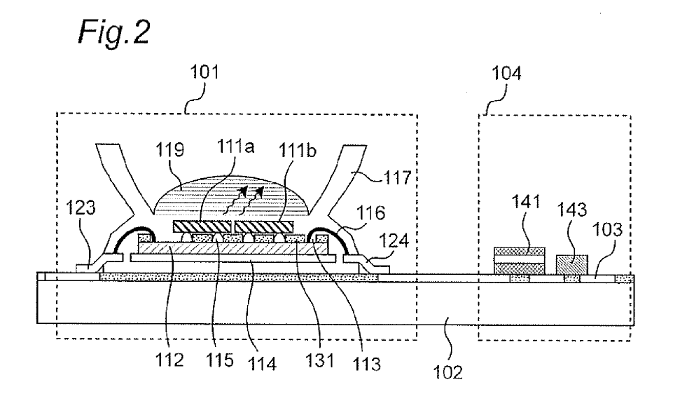

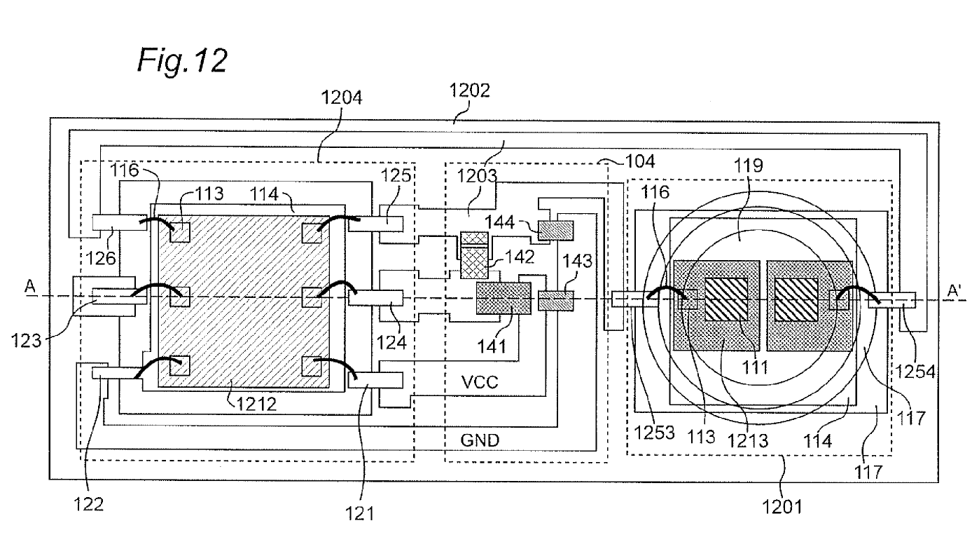

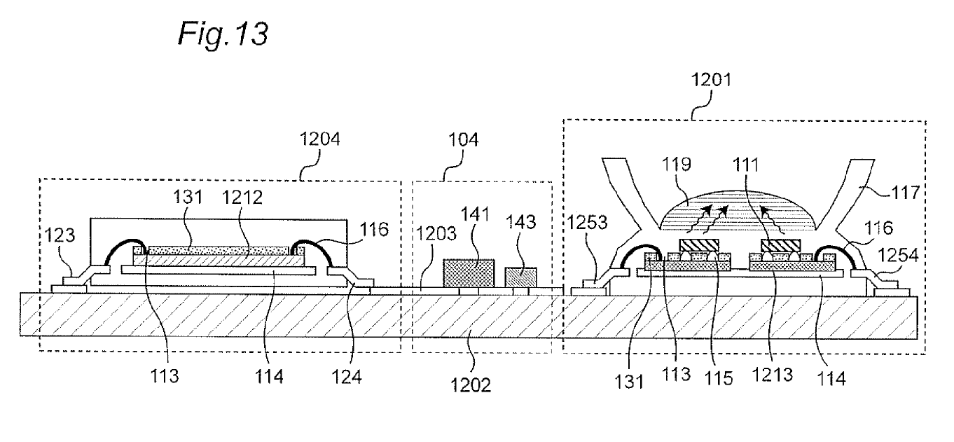

A light emitting device in an embodiment 1 of the invention is described with reference to FIG. 1 to FIG. 7. FIG. 1 is a plan view of the light emitting device in the embodiment 1 of the invention. FIG. 2 is a sectional view cut along broken line A-A′ in FIG. 1. In FIG. 1 and FIG. 2, same elements are identified with same reference numerals. In FIG. 1 and FIG. 2, same elements as in the prior art shown in FIG. 12 and FIG. 13 are identified with same reference numerals.

The light emitting device in the embodiment 1 of the invention has substrate wirings 103 (including a VCC wiring and a GND wiring formed on a substrate 102, and a power supply circuit 104 and a light emitting module 101 are mounted on the substrate wirings 103. Elements of the light emitting module 101 and elements of the power supply circuit 104 are electrically connected by the substrate wirings 103. The VCC wiring is connected to an external power supply, and the GND wiring is connected to a ground potential.

The power supply circuit 104 has an input capacitor 143 connected between the VCC wiring and the GND wiring, a coil 141 connected to the input capacitor 143 by way of the VCC wiring, a Schottky diode 142 connected to the coil 141 by the substrate wiring 103, and at output capacitor 144 having one end connected to the Schottky diode 142 by way of the substrate wiring 103, and other end connected to the GND wiring.

Elements of the light emitting module 101 are explained. The light emitting module 101 has external connection terminals (including a VCC terminal 121, a GND terminal 122, a control terminal 123, a switching terminal 124, and a voltage feedback terminal 125) connected to the power supply circuit 104 by the substrate wiring 103.

The VCC terminal 121 is connected to the VCC wiring. The GND terminal 122 is connected to the GND wiring. The control terminal 123 is usually connected to the output of a control circuit such as microcomputer, and receives a signal for switching on/off the light emitting device.

The switching terminal 124 is connected to the anode terminal of the Schottky diode 142 and the coil 141 by the substrate wiring 103. The voltage feedback terminal 125 is connected to the cathode terminal of the Schottky diode 142 and the output capacitor 144 by the substrate wiring 103.

The light emitting device in the embodiment 1 of the invention does not have a current feedback terminal 126. In the light emitting device of the prior art, the current feedback terminal 126 is connected to the conventional light emitting module 1201, however, in the embodiment 1, since the light emitting elements 111 and a driver IC chip 112 are connected inside the light emitting module 101, the current feedback terminal 126 is not needed.

In the light emitting module 101 in the embodiment 1 of the invention, a lead frame 114 is mounted above the substrate 102, and the driver IC chip (semiconductor chip for driving the light emitting element) 112 is fixed on the lead frame 114. The upside of the driver IC chip 112 is covered with an insulating film 141 except for pad holes 113. The pad holes 113 are portions free from insulating film 131 on the driver IC chip 112. The pad holes 113 are provided for mounting bumps 115, and for connecting bonding wires 116.

Bumps 115 are put on the pad holes 113 except for the area near both ends, and light emitting elements 111a and 111b are mounted on the bumps 115. Bonding wires 116 are connected to five pad holes 113 near the both ends. Internal circuits in the driver IC chip 112 is electrically connected to external connection terminals (the VCC terminal 121, the GND terminal 122, the control terminal 123, the switching terminal 124, and the voltage feedback terminal 125) by way of bonding wires 116.

When the light emitting device of the invention differs from the light emitting device of the prior art lies in that the driver IC chip 112 is built in the light emitting module 101, and that the light emitting elements 111a and 111b are mounted on the driver IC chip 112. Accordingly, the size of the substrate 102 of the invention is smaller than the size of the substrate 1202 of the prior art. In the light emitting device of the invention, since the light emitting elements 111a and 111b are mounted on the driver IC chip 112, the mounting area of light emitting device can be small.

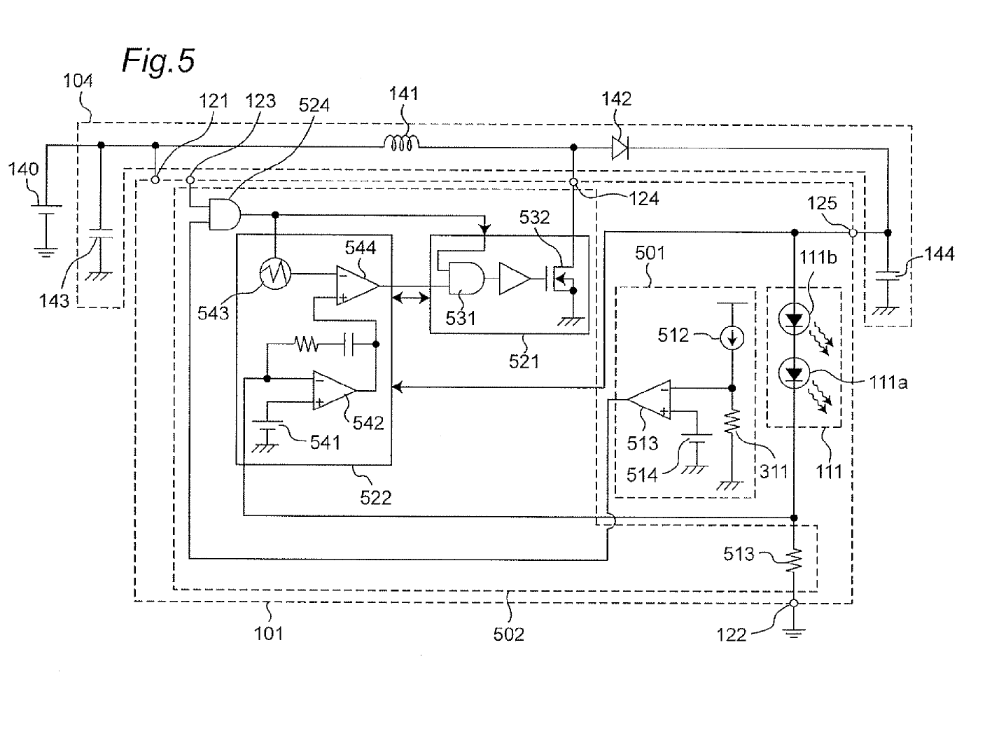

The light emitting elements 111a and 111b (both are collectively indicated as light emitting elements 111 as shown in FIG. 5) are formed of individual chips. In the embodiment 1 of the invention, a plurality of light emitting elements are mounted on the driver IC chip 112. In FIG. 1, to FIG. 7, two light emitting elements 111a and 111b are mounted.

The light emitting elements 111a and 111b are visible light emitting diodes (LEDs). Desired light emitting colors of the light emitting elements can be used. In the embodiment 1, the light emitting elements 111a and 111b are blue light emitting diodes, which emit white light outside through transmission type focusing lens (convex lens) 119 having the surface coated with white fluorescent material. In the invention, the plurality of light emitting elements may emit lights at different wavelengths. The convex lens 119 disposed on the upside of the light emitting elements 111 focuses the light of the light emitting elements 111, intensifies the directivity of light, and heightens the luminance in a direction vertical to the substrate 102.

A light permeable resin mold 117 covers, fixes and protects the entire structure including the light emitting elements 111, the driver IC chip 112, the lead frame 114, and the convex lens 119. The light permeable resin mold 117 focuses the light of the light emitting elements 111, and adjusts the luminance and directivity of light. The upper half of the light permeable resin mold 117 is parabolic form and forms a reflection plane for reflecting and concentrating the total light effectively and enhancing the luminance in a direction vertical to the substrate 102.

In the embodiment 1, the light permeable resin mold 117 and the convex lens 119 are made of a same material to be incorporated. The plurality of light emitting elements 111a and 111b are disposed near the focus of one hemispherical permeable focusing lens 119 having the surface coated with white fluorescent material and one reflection plane 117 which are formed to unify in the light emitting device.

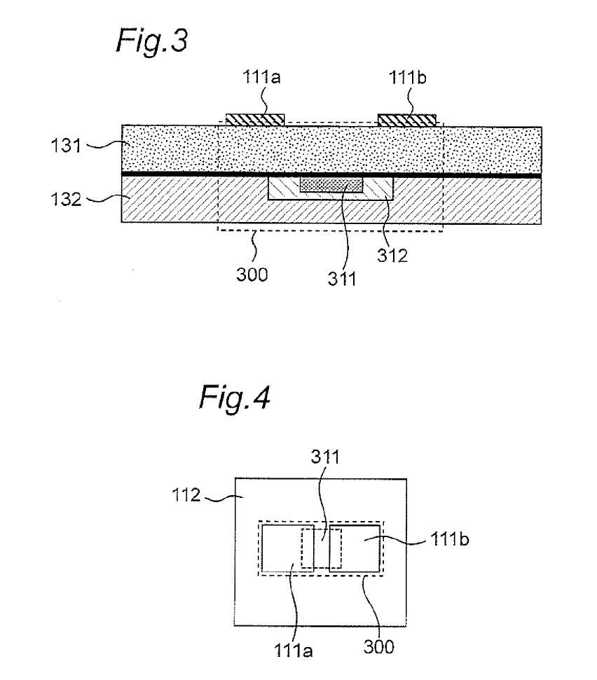

FIG. 3 is a schematic front magnified sectional view showing inside of the driver IC chip. The driver IC chip 112 in FIG. 2 is formed by covering the top of a P type silicon substrate 132 in FIG. 3 with the insulating film 131. A N type well 312 is formed in the top of P type silicon substrate 132, and a P type diffusion resistor 311 is formed inside of the N type well 312. The P type diffusion resistor 311 is a temperature detecting element making use of positive temperature characteristic of resistance.

The upside of the P type diffusion resistor 311 is covered with the insulating film 131. In the embodiment 1, the insulating film 131 is a oxide film (SiO₂). Material of the insulating film 131 is not limited to the oxide film (SiO₂), may be, for example, a nitride film (SiN), a high polymer (polyimide, etc.), or a resin (epoxy, etc.).

FIG. 4 is a schematic plan view of the driver IC chip. FIG. 3 and FIG. 4 show the position of the P type of diffusion resistor (the temperature detecting element) 311 built in the driver IC chip 112. The P type diffusion resistor (the temperature detecting element) 311 is disposed in a light emitting element disposed region 300. Herein, the “light emitting element disposed region” is “a region of minimum rectangular shape including all light emitting elements projected on the driver IC chip.”

The temperature in the light emitting element disposed region 300 is closer to the temperature of the light emitting elements 111. By disposing the temperature detecting element 311 in the light emitting element disposed region 300, the temperature can be detected correctly.

FIG. 5 is a circuit diagram of the light emitting device in the embodiment 1 of the invention. In FIG. 5, same elements as in FIG. 1 to FIG. 4 are identified with same reference numerals. As shown in FIG. 5, the light emitting device in the embodiment 1 of the invention includes a power supply circuit 104 for increasing the voltage output by an external power supply 140, and the light emitting module 101 connected to the power supply circuit 104 by way of external connection terminals (the VCC terminal 121, the switching terminal 124, and the voltage feedback terminal 125).

In the power supply circuit 104, one end of the input capacitor 143 is connected to the external power supply 140. Other end of the input capacitor 143 is connected to the ground potential. A coil 141 is connected to the input power supply 140 and the anode terminal of the Schottky diode 142. The cathode terminal of the Schottky diode 142 is connected to one end of the output capacitor 144. Other end of the output capacitor is connected to the ground potential.

The light emitting module 101 includes the light emitting element 111b and the light emitting element 111a which are applied with the output voltage of the output capacitor 144 through voltage feedback terminal 125, a temperature detecting circuit 501, and a driver circuit unit (light emitting element driving circuit) 502 connected to the light emitting element 111a and the temperature detecting circuit 501. The temperature detecting circuit 501 and the driver circuit unit 502 are circuits formed in the driver IC chip 112 in FIG. 1 and FIG. 2.

The temperature detecting circuit 501 includes a constant current source 512, the temperature detecting element 311 connected between the constant current source 512 and ground potential, a voltage comparator 513 having an inverting input terminal connected to the connection point of the constant current source 512 and the temperature detecting element 311, and a reference voltage 514 connected between a non-inverting input terminal of the voltage comparator 513 and the ground potential. The output of voltage comparator 513 is input to an AND circuit 524.

The temperature detecting element 311 is the P type diffusion resistor shown in FIG. 3. Since the P type diffusion resistor has a characteristic of increasing in the resistance value when the temperature is higher, the terminal voltage of the temperature detecting element 311 becomes higher along with temperature rise. When the terminal voltage of the temperature detecting element 311 exceeds the reference voltage 514, the output of the voltage comparator 513 becomes low.

The driver circuit unit 502 includes an AND circuit 524 having an input terminal connected to the temperature detecting circuit 501 and the control terminal 123, a current detecting resistor 523 connected between the cathode of the light emitting element 111a and the GND terminal 122, a voltage detecting circuit 522 connected between the current detecting resistor 523 and the output terminal of the AND circuit 524, and a driving circuit 521 connected between the output terminal of the AND circuit 524 and the voltage detecting circuit 522.

The AND circuit 524 receives an output signal of the temperature detecting circuit 501 and a control signal entered in the control terminal 123, and outputs a High signal when both are High to drive the driving circuit 521 and the voltage detecting circuit 522. The light emitting elements 111 emit light continuously. The AND circuit 524 stops the operation of the driving circuit 521 and the voltage detecting circuit 522 to stop entire of the driver IC chip 112 if either one of the output signal of the temperature detecting circuit 501 and the control signal entered in the control terminal 123 is Low. At the same time, light emission of the light emitting elements 111 stops. By applying a pulse voltage to the control terminal 123, operation of flashing of the light emitting elements 111 can be repeated.

The voltage detecting circuit 522 includes an error amplifier 542 having an inverting input terminal connected to the connection point of the light emitting element 111a and the current detecting resistor 523, a comparative voltage 541 connected between a non-inverting input terminal of the error amplifier 542 and the ground potential, a PWM comparator 544 having a non-inverting input terminal connected to the output terminal of the error amplifier 542, and a sawtooth wave oscillator 543 connected to a inverting input terminal of the PWM comparator 544.

In the voltage detecting circuit 522, the error amplifier 542, the oscillator 543, and the PWM comparator 544 operate negative feedback so that the voltage between terminals of the current detecting resistor 523 may be equal to the comparative voltage 541 entered in the non-inverting input terminal of the error amplifier 542. The voltage detecting circuit 522 controls the current flowing in the current detecting resistor 523 to be constant, and keeps constant the current flowing in the light emitting elements 111, so that the brightness of light emission is kept constant.

The output terminal of the PWM comparator 544 of the voltage detecting circuit 522 is connected to one input terminal of an AND circuit 531 of the driving circuit 521. Other input terminal of the AND circuit 531 is connected to the output terminal of the AND circuit 524. The output terminal of the AND circuit 531 is connected to a gate of a N channel type MOS transistor 532 by way of an amplifier.

A drain of the N channel type MOS transistor 532 is connected to the connection point of the coil 141 and the Schottky diode 142, and a source of the N channel type MOS transistor 532 is connected to the ground potential. The driving circuit 521 controls the switching operation of the N channel type MOS transistor 532 based on output of the AND circuit 531. By this switching operation, the input voltage applied to the circuit including the coil 141 from the external power supply 140 is increased, and a higher voltage than the input voltage is output to the output capacitor 144.

The voltage of the output capacitor 144 is applied between the anode and a cathode of electric signal terminals being light emitting elements 111a and 111b connected in series through the voltage feedback terminal 125, and the light emitting elements 111a and 111b emit lights. The current flowing in the light emitting elements 111a and 111b is detected as voltage by the current detecting resistor 523 connected in series to the cathode of the light emitting element 111a.

In the light emitting device of the invention thus composed, the operation of supply the light emitting elements 111a and 111b with the constant current in is explained. When the current flowing in the light emitting elements 111a and 111b is increased, the terminal voltage of the current detecting resistor 523 becomes higher. When the terminal voltage of the current detecting resistor 523 becomes higher than the comparative voltage 541, and the voltage difference of the terminal voltage of the current detecting resistor 523 and the comparative voltage 541 becomes larger, the output signal of the error amplifier 542 of the voltage detecting circuit 522 becomes lower.

The output signal of the error amplifier 542 is input to the non-inverting input terminal of the PWM comparator 544, and the output signal of oscillator 543 is input to the inverting input terminal of the PWM comparator 544, so that Low period of the output signal of the PWM comparator 544 becomes longer and High period becomes shorter while the output signal of error amplifier 542 becomes lower. When the output signal of the PWM comparator 544 is high, the N channel type MOS transistor 532 is turned on. Since the ON period is shorter, the amount of current output from the external power supply 140 and accumulated in the coil 141 becomes smaller.

Since the current accumulated in the coil 141 is smaller, the output signal of the PWM comparator 544 is low, and when the N channel type MOS transistor 532 is turned off, the value of voltage applied to the output capacitor 144 and the voltage feedback terminal 125 is smaller. As a result, the current flowing from the voltage feedback terminal 125 to the light emitting element 111a and the light emitting element 111b becomes smaller. Consequently, the terminal voltage of the current detecting resistor 523 is reduced, and the difference between the terminal voltage of the current detecting resistor 523 and comparative voltage 541 becomes smaller.

The operation when the current flowing in the light emitting elements 111a and 111b becomes smaller is reverse to the operation explained above. Thus, the driver circuit unit 502 controls the switching operation of the N channel type MOS transistor 532 so that the terminal voltage of the current detecting resistor 523 may be equal to the comparative voltage 541. In this manner, the driver circuit unit 502 controls so that a constant current may flow in the light emitting element 111a and light emitting element 111b connected in series from the voltage feedback terminal 125.

To the AND circuit 531 for controlling the N channel type MOS transistor 532, the output signal of the AND circuit 524 which receives the output signal of the temperature detecting circuit 501 and the control signal received through the control terminal 123 is input. The P type diffusion resistor has a characteristic of increasing the value of resistance when the temperature is high, and the terminal voltage of the temperature detecting element 311 becomes higher along with temperature rise. When the terminal voltage of the temperature detecting element 311 exceeds the reference voltage 514, the output of the voltage comparator 513 becomes Low. As a result, the output signal of the AND circuit 524 and the output signal of the AND circuit 531 become Low, so that the N channel type MOS transistor 532 stops the switching operation.

Thus, when the temperature of the light emitting elements 111 is higher than the specified upper limit (reference voltage 514) due to heat generation of the light emitting elements 111, the switching operation of the N channel type MOS transistor 532 is stopped to cause light emission of the light emitting elements 111 to be stopped. In this manner, the light emitting device of the invention operates to stop temperature rise of light emitting elements 111, and the light emitting elements 111 is protected from deterioration or breakdown due to operation at high temperature.

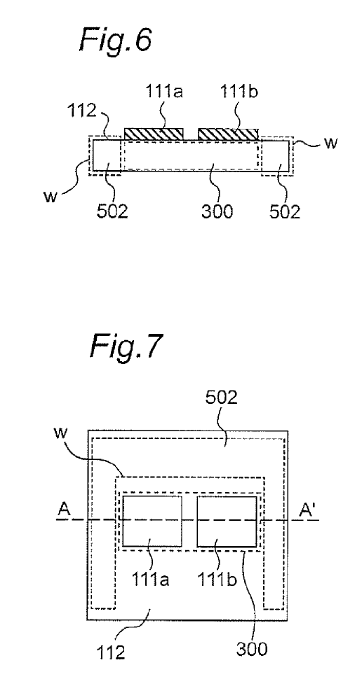

The driver circuit unit 502 shown in FIG. 5 is disposed at the position shown in FIG. 6 and FIG. 7. FIG. 6 and FIG. 7 show the relative positions of the light emitting elements 111 and the driver circuit unit 502 on the driver IC chip 112. FIG. 7 is a plan view of the driver IC chip 112, and FIG. 6 is a sectional view cut along broken line A-A′ in FIG. 7. The frame line w of the driver circuit unit 502 shown in FIG. 6 and FIG. 7 does not show the structure of the driver circuit unit, but shows the region in which the driver circuit unit is disposed.

The driver circuit unit 502 is disposed in a region excluding the light emitting element disposed region 300 in the driver IC chip 112. When the driver circuit unit 502 is disposed in the light emitting element disposed region 300, heat generation of light emitting elements 111 and heat generation of the driver circuit unit 502 may be locally concentrated, and the temperature in the region may be higher. In the embodiment, therefore, the driver circuit unit 502 is formed in a region excluding the light emitting element disposed region 300 on the driver IC chip 112, and the generated heat can be dispersed on the driver IC chip 112, and local temperature peak can be suppressed. By disposing the driver circuit unit 502 as shown in FIG. 6 and FIG. 7, malfunction of driver IC chip 112 can be prevented.

The driver IC chip 112 in the embodiment 1 is a constant current circuit that increases the input voltage to pass specified current to the light emitting elements 111a and 111b. Instead of this constitution, the driver IC chip may a constant voltage circuit that increases the input voltage to apply specified voltage to the light emitting elements 111a and 111b. In a different constitution, the driver IC chip may include a constant voltage circuit for increasing the input voltage to be a specific voltage, and a constant current circuit for passing a specified current to each one of plurality of light emitting elements connected in parallel. The driver IC chip may include a constant current circuit for passing a specified current to light emitting elements 111a and 111b, or a constant voltage circuit for applying a specified voltage to light emitting elements 111a and 111b by decreasing the input voltage.

In FIG. 1 to FIG. 7 of the embodiment 1, two light emitting elements 111 are connected in series, but the number of light emitting elements connected in series is not limited to two, but the invention includes series connection of any number of plurality. The invention also includes a light emitting device having a plurality of pairs connected in parallel, each of which includes a light emitting element and a resistor connected in series to the light emitting element. Of course, only one light emitting element may be used.

In the embodiment 1, one convex lens 119 is disposed on the light emitting elements 111, but a plurality of convex lenses may be disposed depending on the number of light emitting elements. For example, one light emitting element may be combined with one convex lens.

### Embodiment 2

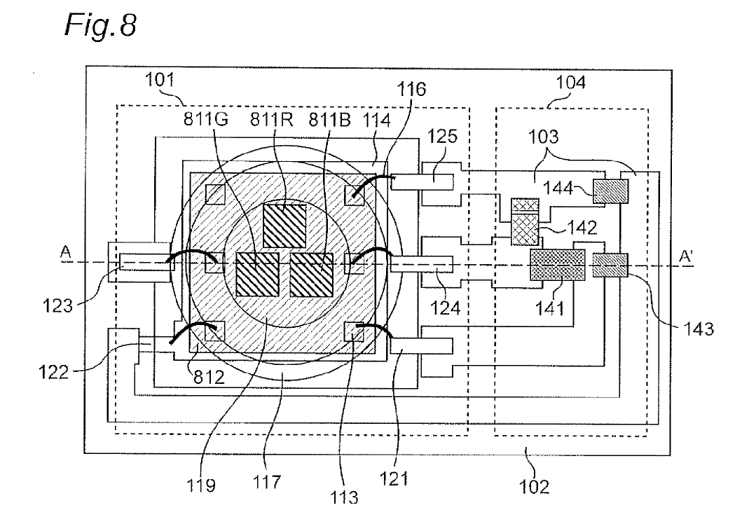

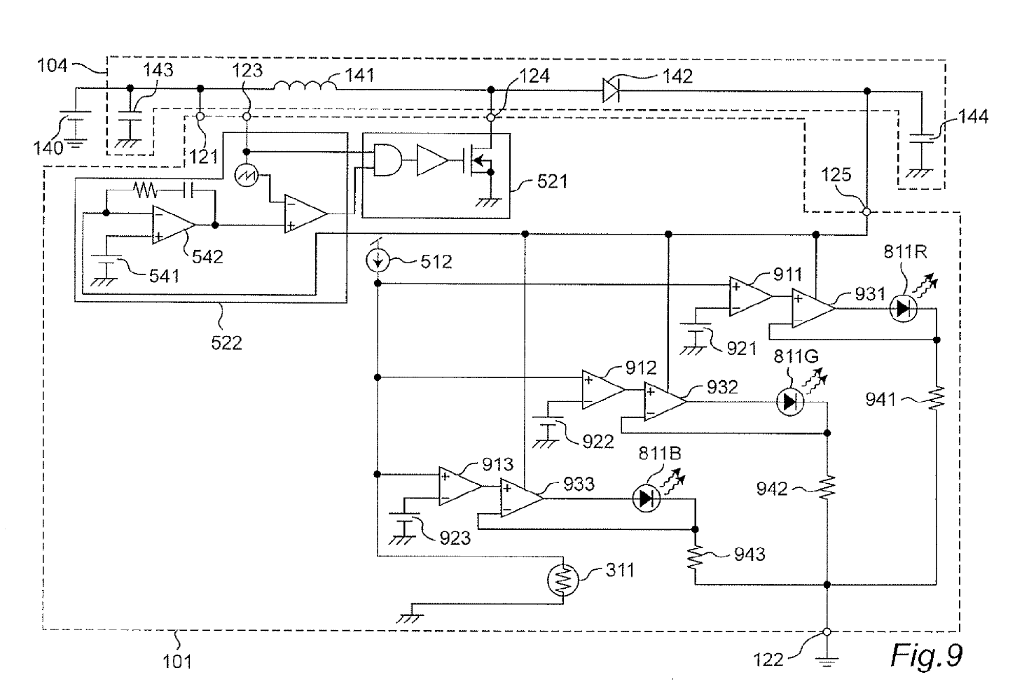

A light emitting device in the embodiment 2 of the invention is described with reference to FIG. 8 and FIG. 9. FIG. 8 is a plan view of the light emitting device in the embodiment 2 of the invention. In FIG. 8, same elements as in FIG. 1 are identified with same reference numerals. What the light emitting device in the embodiment 2 differs from the light emitting device in the embodiment 1 lies in that the light emitting device has three light emitting elements 811, and a driver IC chip 812 of the embodiment 2 instead of the driver IC chip 112 of the embodiment 1. In the embodiment 2, since the other constitution is same as in the embodiment 1, duplicate explanation is omitted. The light emitting device of the embodiment 2 includes a red light emitting element 811R, a green light emitting element 811G, and a blue light emitting element 811B mounted on the driver IC chip 812.

FIG. 9 is a circuit diagram of the light emitting device in the embodiment 2 of the invention. In FIG. 9 of the embodiment 2, same circuit elements as in the embodiment 1 in FIG. 5 are identified with same reference numerals. The light emitting device in the embodiment 2 of the invention includes a power supply circuit 104 and a light emitting module 101 connected to the power supply circuit 104. The power supply circuit 104 is same as that in the embodiment 1.

The light emitting module 101 of the embodiment 2 has a temperature detecting circuit and a driver circuit unit mounted on a driver IC chip 812.

The temperature detecting circuit includes a constant current source 512, a temperature detecting element 311 connected between the constant current source 512 and the ground potential, differential amplifiers 911, 912, 913 having non-inverting input terminal connected to the connection point of the constant current source 512 and the temperature detecting element 311, for signals of light emitting colors R, G, B, reference voltage sources 921, 922, 923 connected between inverting input terminals of the differential amplifiers 911, 912, 913 and the ground potential, and differential amplifiers 931, 932, 933 having the non-inverting input terminals connected to the output terminals of differential amplifiers 911, 912, 913.

The voltages of reference voltage sources 921, 922, 923 are input to inverting input terminals, and the voltage detected by the temperature detecting element 311 is input to the non-inverting input terminal, and the differential amplifiers 911, 912, 913 output the voltage value by amplifying their difference.

The voltage detected by current detecting resistors 941, 942, 943 are input to inverting input terminals, and the output voltages of differential amplifier 911, 912, 913 are input to non-inverting input terminals, and the differential amplifiers 931, 932, 933 output the voltage value by amplifying their difference.

The output terminals of differential amplifiers 931, 932, 933 are connected to anodes of the red light emitting element 811R, the green light emitting element 811G, and the blue light emitting element 811B. The cathodes of red light emitting element 811R, green light emitting element 811G, and blue light emitting element 811B are connected to inverting input terminals of differential amplifiers 931, 932,933.

The gains of differential amplifiers 911, 912, 913 individually vary depending on the luminous efficiency by temperature of RGB. Generally, luminance of light emitting elements of R, G, B is lowered when the temperature rises. In particular, the luminous efficiency of the red light emitting element 811B drops suddenly at high temperature. Accordingly, in the driver circuit unit mentioned below is designed to change the current flowing in light emitting elements of R, G, B depending on the temperature characteristics of elements when the temperature becomes high.

The temperature detecting element 311 is a P type diffusion resistor. When the temperature is high, the resistance of the temperature detecting element 311 is increased. When the terminal voltage of temperature detecting element 311 becomes high, the light emitting device raises the voltage supplied to the light emitting elements 811R, 811G, 811B, to elevate the luminance of light emitting elements. As a result, sudden drop of luminous efficiency at high temperature is compensated, and the white balance of RGB is adjusted.

The differential amplifier 911 for the red light emitting element 811R is higher in the gain of feeding back change amount of the output voltage of the temperature detecting element 311 to the current of light emitting element that other differential amplifiers 912, 913.

The driver circuit unit includes current detecting resistors 941, 942, 943 connected between cathodes of the red light emitting element 811R, the green light emitting element 811G, and the blue light emitting element 811B, and the GND terminal 122, a voltage detecting circuit 522 connected to the voltage feedback terminal 125 and the control terminal 123, and a driving circuit 521 connected between the voltage detecting circuit 522 and the switching terminal 124.

The inverting input terminal of the error amplifier 542 of the voltage detecting circuit 522 is connected to the voltage feedback terminal 125. Other structure of the voltage detecting circuit 522 is same as in the embodiment 1. The voltage detecting circuit 522 operates negative feedback so that the output voltage of the output capacitor 144 may be equal to the comparative voltage 541 input to the non-inverting input terminal of the error amplifier 542.

The internal circuit of the driving circuit 521 is same as in the embodiment 1, and explanation is omitted.

Instead of the configuration of light emitting device in the embodiment 2, the current flowing in green and blue light emitting elements 811G and 811B may be decreased so that the white balance may be maintained when the temperature rises while keeping the current flowing in the red light emitting element 811R constant. When the temperature becomes high, the luminance drops, however, since the white balance is maintained, the user hardly senses strangeness.

The R, G, B light emitting elements of the embodiment are designed to lower the luminance when the temperature becomes high. Not limited to this configuration, it is also possible to use light emitting elements of elevating the luminance when the temperature becomes high.

In the embodiment, a plurality of convex lenses may be provided depending on the number of light emitting elements 811R, 811G, and 811B.

### Embodiment 3

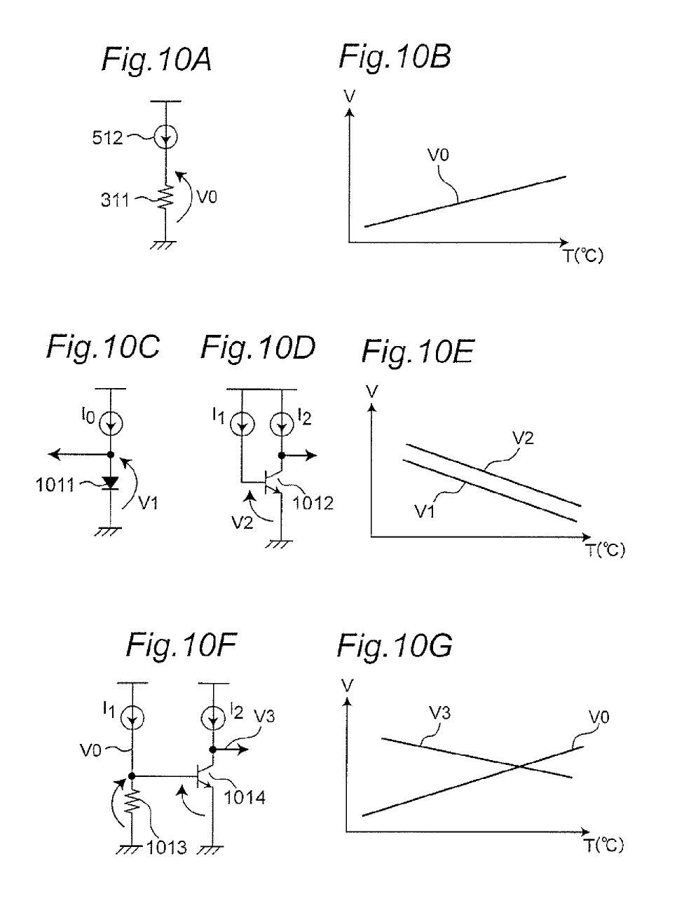

A light emitting device in the embodiment 3 of the invention is described with reference to FIG. 10. FIG. 10 are circuit diagrams showing a internal circuit of a temperature detecting element. What the light emitting device in the embodiment 3 differs from the light emitting device in the embodiment 1 lies only in the temperature detecting element.

FIG. 10A is a temperature detecting element in the embodiment 2. FIG. 10B is a temperature characteristic of FIG. 10A. Each of FIG. 10C, 10D, and 10F is a temperature detecting element in the embodiment 3. FIG. 10E is a temperature characteristic of FIG. 10C and FIG. 10D. FIG. 10G is a temperature characteristic of FIG. 10F. In FIG. 10B, 10E, and 10G, the horizontal axis denotes the temperature, and the vertical axis represents the output voltage.

FIG. 10A shows, for reference, the temperature detecting element in the embodiment 2, having the P type diffusion resistor 311 and the constant current source 512, and FIG. 10B shows its temperature characteristic. This temperature detecting element outputs the voltage V0 at both ends of the P type diffusion resistor 311. The voltage V0 depends on temperature, and the value of voltage is increased when the temperature rises.

The temperature detecting element in FIG. 10C has a diode 1011 having a cathode connected to the ground potential, and a constant current source I₀ connected to an anode of the diode 1011. This temperature detecting element outputs an anode-cathode voltage V1 from the connection point of the diode 1011 and the constant current source I₀. the voltage V1 is decreased when the temperature rises as shown in FIG. 10E.

The temperature detecting element in FIG. 10D has a constant current source I₁, a constant current source I₂, and a bipolar transistor 1012 having the base connected to the constant current source I₁, the collector connected to the constant current source I₂, and the emitter connected to the ground potential. This temperature detecting element outputs a base-emitter voltage V2 from the connection point of the constant current source I₂ and the bipolar transistor 1012. The voltage V2 is decreased when the temperature rises as shown in FIG. 10E.

The temperature detecting element in FIG. 10F has a P type diffusion resistor 1013 having one end connected to the ground potential, a constant current source I₁ connected to other end of the P type diffusion resistor 101, a bipolar transistor 1014 having the base connected to the connection point of P type diffusion resistance 101 and the constant current source I₁, and the emitter connected to the ground potential, and a constant current source I₂ connected to the collector of the bipolar transistor 1014. This temperature detecting element outputs a collector voltage V3 of the bipolar transistor 1014 from the connection point of the constant current source I₂ and the bipolar transistor 1014. The base voltage of the bipolar transistor 1014 is given by voltage V0 at the connection point of the constant current source I₁ and the resistor 1013. The voltage V0 is increased and V3 is decreased when the temperature rises as shown in FIG. 10G.

As shown in FIG. 10C, 10D, and 10F, the temperature detecting element of the embodiment 3 has a circuit for feeding back a temperature depending on whether the characteristic is positive or negative in relation to the temperature parameter.

Except for the polarity and gain of feedback, the structure of the embodiment 3 is same as in the embodiments 1 and 2 except the temperature detecting elements. Duplicate explanation is omitted. Since the structure of essential parts in the embodiment 3 is the same, the same effects as in the embodiments 1 and 2 are obtained. In this the embodiment, combinations of number of light emitting elements and number of convex lenses is arbitrary, same as in the embodiment 1.

### Embodiment 4

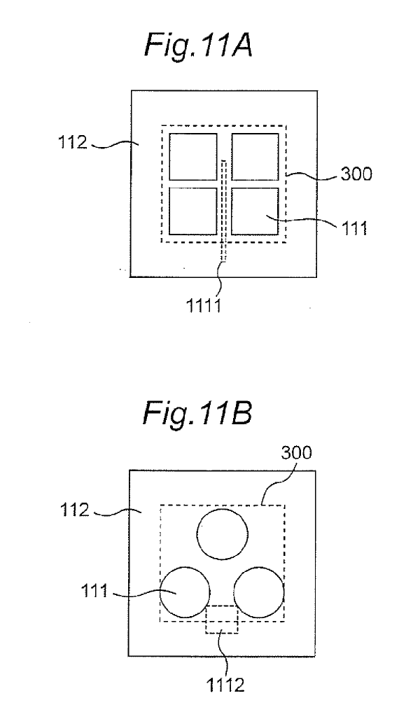

A light emitting device in the embodiment 4 of the invention is described with reference to FIG. 11. FIG. 11 is a plan view showing the position of a temperature detecting element incorporated in the driver IC chip in the embodiment 4 of the invention. What the light emitting device in the embodiment 4 differs from the embodiment 1 lies only in the position of temperature detecting elements.

FIG. 11A is a diagram showing a region for disposing a temperature detecting element when four square light emitting elements 111 are disposed. FIG. 11B is a diagram showing a region for disposing a temperature detecting elements when three circular light emitting elements 111 are disposed.

In the embodiment 1, the whole temperature detecting element 311 (in FIG. 3 and FIG. 4) are disposed in light emitting element disposed region 300. In the embodiment 4, part of regions 1111 and 1112 for disposing a temperature detecting element (in FIGS. 11) is present within the light emitting element disposed region 30C. When at least part of the temperature detecting element is disposed in light emitting element disposed region 300 as in the embodiment 4, temperature of light emitting elements can be accurately detected, and breakdown or deterioration of light emitting elements can be prevented.

In FIG. 11, the region of each light emitting element projected on the driver IC chip is not overlapped with the disposed regions 1111 and 1112 of the temperature detecting element. In a light emitting device having a plurality of light emitting elements, if part of the regions 1111 and 1112 for disposing the temperature detecting element is disposed immediately beneath a specific light emitting element (in a region of light emitting element projected on the driver IC chip), the temperature detecting element may have an excessive effect of heat generation of the specific light emitting element. As shown in FIG. 11, since disposed regions 1111 and 1112 of the temperature detecting element are not present immediately beneath any light emitting element, the temperature detecting element can detect correctly the average temperature of all light emitting elements.

In the light emitting device of the embodiment 4, the structure is the same as in the embodiments 1 to 3 except for layout of temperature detecting element. Duplicate explanation is omitted. Since the structure of essential parts of the light emitting device in the embodiment 4 is the same, the same effects as in the embodiments 1 to 3 are obtained. In this the embodiment, combinations of number of light emitting elements and number of convex lenses is arbitrary, same as in the embodiment 1.

A lighting equipment can be made by connecting in parallel a plurality of light emitting devices in any one of the embodiments 1 to 4.

Although the present invention has been described with respect to its preferred embodiments in some detail, the disclosed contents of the preferred embodiments may change in the details of the structure thereof, and any changes in the combination and sequence of the component may be attained without departing from the scope and spirit of the claimed invention.

### INDUSTRIAL APPLICABILITY

The invention is useful for a semiconductor chip for driving a light emitting element, a light emitting device, and a lighting equipment.

1. A light emitting device comprising:
a light emitting element having an electric signal terminal, that is driven to emit light by an electric signal given from outside to the electric signal terminal; and
a semiconductor chip for driving the light emitting element, including a light emitting element driving circuit and a temperature detecting element that are made of a semiconductor, the light emitting element driving circuit outputting and applying the electric signal to the electric signal terminal, the temperature detecting element detecting an ambient temperature,
wherein the light emitting element is mounted on the semiconductor chip for driving the light emitting element, and is driven based on the temperature detected by the temperature detecting element.

2. The light emitting device according to claim 1, wherein at least part of the temperature detecting element is disposed in a light emitting element disposed region that is a minimum region including the light emitting element projected on the semiconductor chip for driving the light emitting element.

3. The light emitting device according to claim 1, wherein the light emitting element driving circuit is formed in the semiconductor chip for driving the light emitting element excluding the light emitting element disposed region.

4. The light emitting device according to claim 1, wherein the light emitting element is a plurality of visible light emitting elements that emit light at different wavelengths, and the semiconductor chip for driving the light emitting element drives the light emitting elements individually to maintain white balance of the plurality of light emitting elements based on the temperature detected by the temperature detecting element.

5. A lighting equipment comprising:
a plurality of the light emitting devices according to claim 1.

6. A semiconductor chip for driving a light emitting element, on which the light emitting element can be mounted, the light emitting element having an electric signal terminal and driven to emit light by an electric signal given to the electric signal terminal from outside, the semiconductor chip comprising:
a light emitting element driving circuit that outputs and applies the electric signal to the electric signal terminal; and
a temperature detecting element that detects an ambient temperature,
wherein the semiconductor chip drives the light emitting element based on the temperature detected by the temperature detecting element.

7. The semiconductor chip for driving a light emitting element according to claim 6, wherein at least part of the temperature detecting element is disposed in a light emitting element disposed region which is a minimum region including the light emitting element projected on the semiconductor chip for driving the light emitting element.

8. The semiconductor chip for driving a light emitting element according to claim 6, wherein the light emitting element driving circuit is formed in the semiconductor chip for driving the light emitting element excluding the light emitting element disposed region.

9. The semiconductor chip for driving a light emitting element according to claim 6, wherein the light emitting element is a plurality of visible light emitting elements that emit light at different wavelengths, and the semiconductor chip for driving the light emitting elements drives the light emitting elements individually to maintain white balance of the plurality of light emitting elements based on the temperature detected by the temperature detecting element.
